(19) United States
(12) Patent Application Publication
(10) Pub. No.: US 2017/0053473 A1
(43) Pub. Date: Feb. 23, 2017

(54) SYSTEMS AND TICKETS FOR PLAYING SCRATCH-OFF GAMES OF CHANCE

(71) Applicant: Gaming Arts, LLC, Las Vegas, NV (US)

(72) Inventors: David Colvin, Las Vegas, NV (US); Jamal M. Azzam, Reno, NV (US)

(21) Appl. No.: 15/242,317

(22) Filed: Aug. 19, 2016

Related U.S. Application Data
(60) Provisional application No. 62/207,154, filed on Aug. 19, 2015.

(51) Int. Cl. G07F 17/32; A63F 3/06

(52) U.S. Cl. CPC G07F 17/329; A63F 3/0665; A63F 3/0645; G07F 17/3246; G07F 17/3253; G07F 17/3248; G07F 17/3288

(57) ABSTRACT

A player ticket includes a first layer having at least one player card including a plurality of spaces. A player indicia and/or a matched indicia is displayed within each space, and each matched indicia represents a player indicia that matches a house indicia selected for the game of chance. The ticket includes at least one multiplier portion that displays a prize multiplier for the player card. The ticket also includes a second layer having a removable material disposed upon at least a portion of the player card and the multiplier portion. Removing the removable material causes the player indicia, the matched indicia, and the prize multiplier to be revealed to a player.

### CROSS REFERENCE TO RELATED APPLICATIONS

This application claims the benefit of U.S. Provisional Application Ser. No. 62/207,154 filed Aug. 19, 2015, entitled “Systems and Tickets for Playing Scratch-Off Games of Chance”, the disclosure of which is hereby incorporated by reference in its entirety.

### BACKGROUND

The present application relates generally to games of chance and, more particularly, to systems and tickets for playing scratch-off games of chance.

Scratch-off tickets are a popular way to play lottery games and other games of chance. Typical scratch-off tickets include one or more game indicia that are covered by a scratch-off material. A player purchases one or more scratch-off tickets and then removes the scratch-off material with a coin, a fingernail, or the like to see if any of the tickets are winning tickets. If any ticket is a winning ticket, the player may win a prize for that ticket.

Variations of the scratch-off ticket exist as well. Some tickets may include a removable pull tab that a player disengages from the ticket to reveal underlying game indicia. Other tickets may include additional ways to initially hide game indicia until a player purchases the ticket. While a variety of tickets exist, players often look for new and exciting ways to play games of chance.

### BRIEF SUMMARY

In one embodiment, a player ticket for use in a game of chance is provided that includes a first layer and a second layer. The first layer includes at least one player card having a plurality of spaces. At least one of a player indicia and a matched indicia is displayed within each space, and each matched indicia represents a player indicia that matches a house indicia selected for the game of chance. The first layer also includes at least one multiplier portion that displays a prize multiplier for the at least one player card. The second layer includes a removable material disposed upon at least a portion of the at least one player card and the at least one multiplier portion. Removing the removable material causes the player indicia, the matched indicia, and the prize multiplier to be revealed to a player.

In another embodiment, a player ticket for use in a game of chance is provided that includes a first layer and a second layer. The first layer includes at least one player card having a plurality of spaces. At least one of a player indicia and a matched indicia is displayed within each space, and each matched indicia represents a player indicia that matches one of a plurality of house indicia that have been selected for the at least one player card. The first layer also includes a caller portion that displays a number of the plurality of house indicia that have been selected for the game of chance. The second layer includes a removable material disposed upon at least a portion of the at least one player card and the caller portion. Removing the removable material causes the player indicia, the matched indicia, and the caller portion to be revealed to a player.

In another embodiment, a player ticket for use in a game of chance is provided that includes at least one player card having a plurality of spaces. At least one of a player indicia and a matched indicia is displayed within each space, and each matched indicia represents a player indicia that matches one of a plurality of house indicia that have been selected for the at least one player card. The ticket also includes at least one pattern portion that displays a winning pattern to be matched for the at least one player card and at least one pay table that displays a prize to be won upon a determination that the matched indicia within the at least one player card matches the winning pattern. The ticket also includes a removable material disposed upon at least a portion of at least one player card and at least a portion of the at least one pattern portion. Removing the removable material causes the player indicia, the matched indicia, and the winning pattern to be revealed to a player.

In another embodiment, a player ticket for use in a game of chance includes at least one player card having a plurality of spaces. At least one of a player indicia and a matched indicia is displayed within each space, and each matched indicia represents a player indicia that matches one of a plurality of house indicia that have been selected for the at least one player card. The ticket also includes at least one bonus portion that displays whether a bonus indicia has been selected for the at least one player card, and at least one pay table that displays a prize to be won upon a determination that the matched indicia within the at least one player card forms a winning pattern. The ticket also includes a removable material disposed upon at least a portion of at least one player card and at least a portion of the at least one bonus portion. Removing the removable material causes the player indicia, the matched indicia, and any selected bonus indicia to be revealed to a player.

In yet another embodiment, a player ticket for use in a game of chance is provided that includes a first player card having a first plurality of spaces. At least one of a player indicia and a matched indicia is displayed within each of the first plurality of spaces, and each matched indicia represents a player indicia that matches one of a plurality of house indicia that have been selected for the first player card. The ticket also includes a second player card incorporated within the first player card. The second player card includes a second plurality of spaces that is a subset of the first plurality of spaces. The ticket also includes a first pay table and a second pay table. The first pay table displays a first prize to be won upon a determination that the matched indicia within the first player card matches a first winning pattern. The second pay table displays a second prize to be won upon a determination that the matched indicia within the second player card matches a second winning pattern. The ticket also includes a removable material disposed upon at least a portion of the first player card and the second player card. Removing the removable material causes the player indicia and the matched indicia within the first player card and the second player card to be revealed to a player.

In another embodiment, a system for use in a game of chance is provided that includes a player ticket having at least one player card that includes a plurality of spaces. At least one of a player indicia and a matched indicia is displayed within each space, and each matched indicia represents a player indicia that matches one of a plurality of house indicia that have been selected for the at least one player card. The ticket also includes at least one pay table that displays a prize to be won upon a determination that the matched indicia within the at least one player card matches a winning pattern, and a removable material disposed upon at least a portion of the at least one player card. Removing the removable material causes the player indicia and the matched indicia to be revealed to a player. The ticket also includes a ticket identifier that enables the player to determine whether the player is enabled to win the prize for the at least one player card without removing the removable material. The system also includes a device configured to read the ticket identifier, determine whether the player is enabled to win the prize for the at least one player card, and display a notification of whether the player is enabled to win the prize.

In still another embodiment, a gaming device is provided that includes a processor programmed to present a game of chance to a player, a display, and a player ticket configured to be displayed on the display. The player ticket includes at least one player card comprising a plurality of spaces. At least one of a player indicia and a matched indicia is displayed within each space, and each matched indicia represents a player indicia that matches one of a plurality of house indicia that have been selected for at least one player card. The player ticket also includes at least one pay table that displays a prize to be won upon a determination that the matched indicia within the at least one player card matches a winning pattern. The player ticket also includes a covering disposed upon at least a portion of the at least one player card. Removing the covering causes the player indicia and the matched indicia to be revealed to the player. The gaming device also includes an input device configured to accept an input from the player. The processor is programmed to remove the covering from the at least one player card in response to the input.

### BRIEF DESCRIPTION OF THE DRAWINGS

Embodiments are illustrated in the following figures in which similar components are labeled with the same reference numerals.

FIG. 1 is an exploded side view of an exemplary ticket that may be used to play a scratch-off game of chance.

FIGS. 2A and 2B are plan views of an exemplary ticket that may be used to play a scratch-off game of chance.

FIGS. 3A and 3B are plan views of an exemplary ticket that may be used to play a scratch-off game of chance.

FIGS. 4A and 4B are plan views of an exemplary ticket that may be used to play a scratch-off game of chance.

FIGS. 5A and 5B are plan views of an exemplary ticket that may be used to play a scratch-off game of chance.

FIGS. 6A and 6B are plan views of an exemplary ticket that may be used to play a scratch-off game of chance.

FIGS. 7A and 7B are plan views of an exemplary ticket that may be used to play a scratch-off game of chance.

FIGS. 8A and 8B are plan views of an exemplary ticket may be used to play a scratch-off game of chance.

FIG. 9 is a plan view of an exemplary ticket that may be used to play a scratch-off game of chance.

FIG. 10 is a block diagram of an exemplary player card that may be used to play a scratch-off game of chance.

FIG. 11 is a block diagram of an exemplary system that may be used to play a scratch-off game of chance using electronic or virtual tickets and/or player cards similar to the tickets and/or player cards shown in FIGS. 1-10.

FIG. 12 is a block diagram of a computing device that may be used with the system shown in FIG. 11.

FIG. 13 is a block diagram of a gaming device that may be used with the system shown in FIG. 11.

### DETAILED DESCRIPTION

Embodiments described herein provide physical or virtual player tickets, such as scratch-off tickets, for playing one or more games of chance. In one embodiment, a scratch-off game of bingo is played by matching player indicia on one or more player cards to house indicia that are selected or called for the game. The house indicia are preselected and may be marked on the ticket before the ticket is sold to the player. In one embodiment, the player indicia on the player card or cards on the ticket are daubed or otherwise marked as matched indicia if the player indicia matches a house indicia selected for the game. If the matched indicia for a player card matches a winning criterion, such as a winning pattern, the player may win a prize for the player card.

Winning patterns are patterns of matched indicia that match patterns identified in an associated pay table. Examples of winning patterns for a scratch-off bingo game may include, without limitation, a coverall or blackout pattern, a frame pattern, a single pattern, a double pattern, a letter X pattern, a letter T pattern, and the like.

In one embodiment, a scratch-off ticket includes a player card portion and a pattern portion that are initially covered by a removable scratch-off material. Alternatively, one or more portions of the ticket are initially covered by a removable pull-tab or another removable material. The player card portion includes one or more player cards with a plurality of spaces for displaying player indicia and/or matched indicia. The pattern portion may display a winning pattern that must be matched for each player card and a pay table for each winning pattern and/or player card. The pay table for each player card may display one or more prizes that the player may in if matched indicia on the player card forms the winning pattern.

In one embodiment, the scratch-off ticket also includes one or more of a multiplier portion, a caller portion, and/or a bonus portion. Each of these portions may initially be wholly or partially covered by the scratch-off material. The multiplier portion may display a multiplier for one or more prizes won by the player. The caller portion may identify how many house indicia have been called for each player card and/or ticket. The caller portion may additionally display each house indicia that has been selected for each player card for the game. The bonus portion may display a bonus status that indicates whether a bonus indicia has been selected for each player card. The bonus indicia may cause a prize to be increased, an otherwise unmatched winning pattern to be completed, one or more free games to be awarded, and/or any other suitable bonus to be awarded to the player.

In one embodiment, one or more ticket identifiers, such as one or more bar codes or serial numbers, may be provided on each ticket. The ticket identifier may enable the player to determine whether the ticket includes any winning player cards (i.e., any player cards that have matched indicia that form a winning pattern or that: satisfy any other winning criterion). The ticket identifier may enable the player to visit a website to determine whether the ticket includes any winning player cards, and/or the ticket identifier may be readable by a device that determines whether the ticket includes any winning player cards. In one embodiment, the player may use the ticket identifier to determine whether the ticket has any winning player cards even without removing the scratch-off material covering the player cards.

In another embodiment, the scratch-off tickets may be implemented electronically by one or more gaining devices. In such an embodiment, the ticket and associated player cards may be displayed on a display of the gaming device. The player cards, or portions thereof, may be initially covered by a virtual scratch-off material, such as a logo, an image, a color, a pattern, and/or any other suitable covering that obscures the contents of the player card spaces. If the display is a touch sensitive display, the player may touch each space to remove the virtual scratch-off material. In another embodiment, the player may use another input device, such as one or more buttons, a keyboard, a pointing device, or the like to select a space and remove the virtual scratch-off material from that space. Alternatively, the player may select an icon or the like to remove the virtual scratch-off material from all spaces or a group of spaces. If a winning pattern of matched indicia is revealed, the player may receive a prize associated with the winning pattern.

While certain aspects of the scratch-off cards and associated devices and systems are described individually or separately within each embodiment, it should be recognized that the aspects of one or more embodiments may be combined as desired. While certain scratch-off ticket embodiments describe player cards with 5×5 matrices of spaces, it should be recognized that any suitable matrix or arrangement of spaces may be used. For example, player cards may be arranged as a 6×15 matrix of spaces or any other suitable arrangement.

As used herein, a “game of chance” or “game” refers to a game that is played by a player in which an outcome of the game of chance is at least partially based on chance or a random selection of game components. It should be recognized by those of ordinary skill in the art that the term “random” is not limited to true randomness, such as truly random numbers. Rather, pseudorandom numbers and pseudorandom algorithms are included within the meaning of “random.” In addition, those of ordinary skill in the art will recognize that permutation generators may additionally or alternatively be used to generate player card indicia.

As used herein, the term “pattern-based” game refers to a game in which the winning criterion includes matching one or more patterns of player indicia with called house indicia. As a non-limiting example, bingo and bingo-related games may be considered pattern-based games. It should be recognized, however, that bingo and bingo-related pattern-based games may use more or less than 75 house indicia and/or may end with no winner being identified in contrast to traditional bingo games. Non-limiting examples of games that are not pattern-based games include keno and keno-related games, including keno and keno-related games that use more or less than the traditional 80 house indicia.

Gaming devices described herein may use real money for play, or may utilize a credit-based system in which the credits used for the games do not have a cash value. Similarly, prizes for the games may be in the form of credits, cash, and/or physical prizes such as televisions, automobiles, or the like.

In one embodiment, the play of a game, or the gameplay, includes the drawing or selection of a plurality of house indicia for one or more player cards. Alternatively, the play of a game may include revealing the house indicia that have been pre-selected for one or more player cards.

The term “house indicia” or “game indicia” refers to indicia generated, called, or otherwise selected by a gaming establishment or an operator of the game (or by software, devices, and/or agents operating on behalf of the gaming establishment or operator). In one embodiment, house indicia are compared to player indicia on each player card to determine if each player card satisfies one or more winning conditions.

As used herein, the term “player indicia” refers to indicia, such as objects, graphics, symbols, numbers, letters, or the like, that are printed on, displayed on, or otherwise associated with a player card used by the player to play a game of chance. In at least some embodiments, the player indicia for each player card are selected before the player card is issued or distributed to a player.

The term “ball call” or “house indicia call” refers to a random selection of house indicia in connection with a game of chance. A ball call may generally refer to a random selection of a number or another suitable house indicia using a randomization device. A “ball,” as used herein, may be a round plastic, wood, or glass spherical object with a number or other indicia displayed thereon, or may be an electronic representation of a spherical object with a number or other indicia displayed thereon. It should be recognized that the term “ball” may also include non-spherical objects or electronic representations, such as cubes, electronic images, and/or the numbers or indicia by themselves.

As used herein, the term “pattern” refers to a predetermined combination of spaces of a player card or to a predetermined combination of indicia within the spaces. In at least some embodiments, a winning pattern is satisfied if a predetermined combination of player indicia included within the spaces of a player card are matched to house indicia called during the game.

As used herein, the terms “connect” and “couple” are not limited to only including direct connections. Rather, unless otherwise specified, indirect connections are included within the definitions of “connect” and “couple.” For example, two devices may be considered to be connected together even if there are other devices or components connected between the two devices. Any suitable means to connect or couple devices or components together may be used.

A player reward card refers to a physical or electronic card, token, or other device or data that enables a system to identify a player in connection with, among other things, a reward program or campaign. Accordingly, the player reward card may serve to identify the player and may enable gameplay, credits, funds, or other data to be associated with the player.

A player ticket (sometimes referred to as a “ticket”) may include one or more player cards for playing a game of chance. The player ticket may be a physical ticket that is manufactured from paper, cardboard, cardstock, plastic, and/or any other suitable material. Alternatively, the player ticket may be an electronic or virtual ticket that is transmitted to and/or generated by a device usable by the player to play the game of chance.

A player card refers to a card or other representation of player indicia that may be used by the player to play bingo or another game of chance. The player card typically includes a plurality of spaces that may display or include the player indicia.

Methods described herein may be embodied within a plurality of instructions stored within a memory device of a computing device. Moreover, a processor of the computing device, or of a computing device coupled to the memory device, executes the instructions to perform the functions described herein and/or to cause the functions described herein to be performed. The instructions may be grouped together to form one or more computer-readable program modules.

Computing devices typically include at least one processor and at least one memory device. The processor may be, without limitation, an x86-based logic circuit, an ARM-based logic circuit, and/or a system-on-a-chip circuit. It should be recognized that these examples are non-limiting, and a variety of other programmable circuits may be included within the definition of “processor.” The memory device may include random access memory (RAM), flash memory, read-only memory (ROM), hard disk drives, magnetic-based memory, and/or any other form of computer-readable memory.

A desktop computer is one example of a computing device. Other examples of computing devices include, without limitation, electronic gaming machines (also known as slot machines), kiosks, video lottery terminals, cell phones, tablets, PDAs, laptop computers, and smart watches. It should be recognized that computers or computing devices may be implemented as one or more virtual machines, virtual servers, and/or any other virtual device. A server is another type of computing device that may receive network connections from a computer or a plurality of computers or other computing devices.

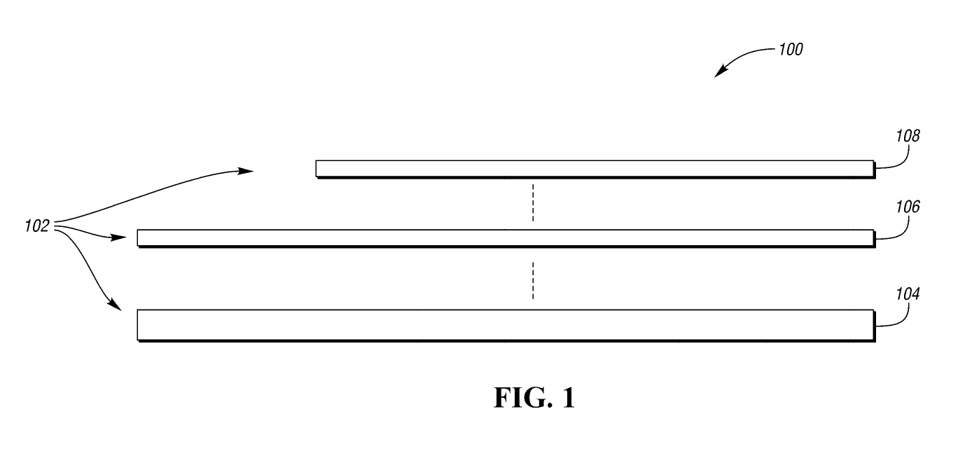

FIG. 1 is an exploded side view of an exemplary ticket 100 that may be used to play a game of chance, such as bingo. In one embodiment, ticket 100 is a scratch-off ticket that may be used to play a scratch-off bingo game.

In one embodiment, ticket 100 includes a plurality of layers 102 that are placed or formed on top of each other. For example, ticket 100 may include a base layer 104 that is substantially rigid to enable a player to hold ticket 100 and scratch off portions of ticket 100 to play the game. In one embodiment, base layer 104 includes cardboard, card stock, paper, plastic, or another suitable material.

Ticket 100 may also include a player card layer 106 that displays one or more player cards and/or other game information to the player. In one embodiment, player card layer 106 is printed on top of base layer 104.

Ticket 100 may also include a scratch-off layer 108 that is disposed on one or more portions of player card layer 106 to cover or obscure portions of player card layer 106. For example, scratch-off layer 108 may include a scratch-off material that is disposed upon parts or all of the player cards of player card layer 106 to cover or obscure the contents of the player cards from a player until the player scratches off, or otherwise removes, the scratch-off material.

While ticket 100 is illustrated in FIG. 1 as having 3 layers 102, it should be recognized that ticket 100 any suitable number and/or types of layers 102 in addition to, or in place of, layers 102 described herein. For example, in one embodiment, two or more layers 102 may be integrally formed together rather than being separate layers 102.

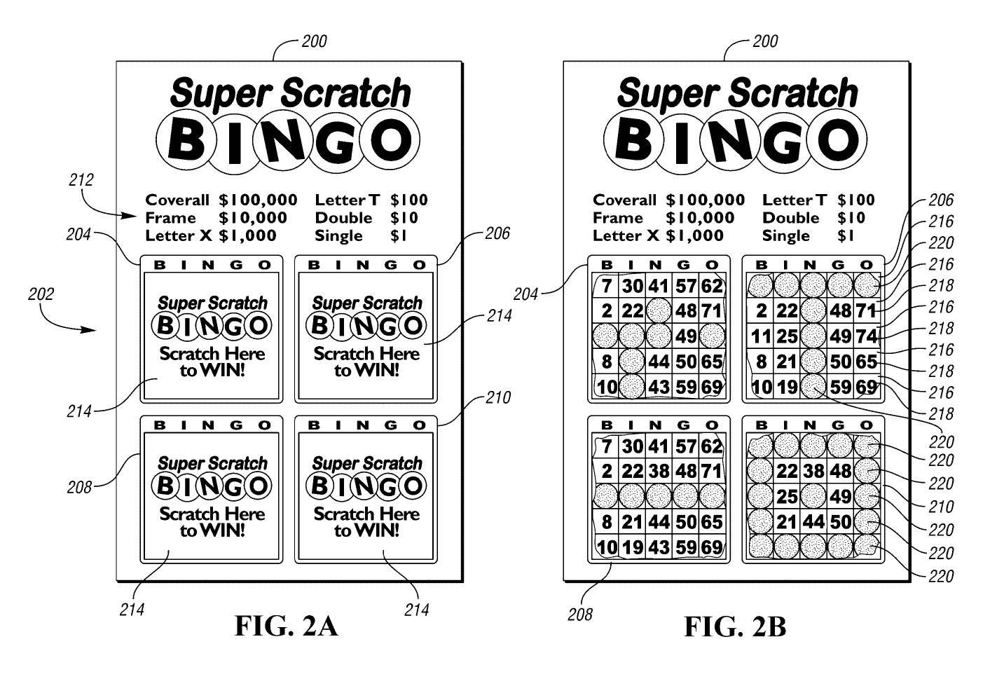

FIG. 2A is a plan view of an exemplary ticket 200 that may be used to play a game of chance, such as bingo. In one embodiment, ticket 200 is a scratch-off ticket that may be used to play a scratch-off game of bingo. FIG. 2B is a plan view of ticket 200 that has been scratched off or otherwise revealed by the player. In one embodiment, ticket 200 includes a plurality of layers in a similar manner as ticket 100 (shown in FIG. 1).

In one embodiment, ticket 200 includes a plurality of player cards 202, including a first player card 204, a second player card 206, a third player card 208, and a fourth player card 210. Alternatively, ticket 200 may include any suitable number of player cards 202. In one embodiment, ticket 200 ma also include a pay table 212 and a scratch-off material 214 covering at least a portion of player cards 202.

Player cards 202 include a plurality of spaces 216 for displaying player indicia 218 and/or matched indicia 220. In one embodiment, player cards 202 are arranged in a 5×5 matrix of spaces 216 with a “free” space in the center space 216. The columns at the top of each player card 202 may be labeled with the letters “BINGO”. Player indicia 218 are then randomly selected for each space 216 in player card 202. In an embodiment in which the numbers 1-75 are used for the house indicia, player indicia 218 for spaces 216 in the “B” column are randomly selected from the numbers 1-15, player indicia 218 for spaces 216 in the “I” column are randomly selected from the numbers 16-30, player indicia 218 for spaces 216 in the “N” column are randomly selected from the numbers 31-45, player indicia 218 for spaces 216 in the “G” column are randomly selected from the numbers 46-60, and player indicia 218 for spaces 216 in the “O” column are randomly selected from the numbers 61-75. In one embodiment, the center space in the “N” column is a “free” space that is considered to be automatically matched by the player regardless of which house indicia and player indicia 218 are selected for player card 202.

Pay table 212 identifies the prize or prizes that a player may win by satisfying a designated winning criterion for each player card 202. In one embodiment, the winning criterion may include matching a winning pattern by the matched indicia on a player card 202. The prize may include, for example, a predetermined amount of money. Alternatively, the prize may include merchandise or any other suitable prize.

In one embodiment, scratch-off material 214 is disposed upon player cards 202 to cover each space 216 until the player scratches off or otherwise removes scratch-off material 214. Scratch-off material 214 may include a latex ink covering, an aluminum-based covering, an ultraviolet ink covering, an acrylic resin, or any other suitable material.

Player indicia 218 may include objects, graphics, symbols, numbers, letters, or the like. Player indicia 218 are preselected before ticket 200 is sold to the player and are printed or otherwise displayed within player card 202.

Matched indicia 220 are player indicia 218 that match the house indicia that are called or selected for the game or player card 202. In one embodiment, matched indicia 220 are represented by a daub symbol (i.e., are “daubed”) or otherwise marked on player card 202 to allow the player to easily distinguish between player indicia 218 that have been matched and player indicia 218 that have not been matched by house indicia. In one embodiment, matched indicia 220 are daubed on top of the player indicia 218 that are matched such that player indicia 218 is at least partially overlaid with the daub symbol. In an alternative embodiment, matched indicia 220 are displayed on player card 202 with a daub symbol instead of the player indicia 218 that would otherwise be displayed in the space 216 for the matched player indicia 218. In such an embodiment, printing costs may be reduced since a player indicia 218 that would otherwise be obscured by the matched indicia 220 daub symbol would not need to be printed on player card 202.

When a player wants to play the game of chance, the player purchases one or more tickets 200 by placing an appropriate wager with a cashier or the like. Each ticket 200 and/or player card 202 may be associated with a separate game session such that each ticket 200 and/or player card 202 has a different set of called house indicia associated with it. Alternatively, a group of tickets 200 and/or player cards 202 may all be associated with a single game session such that one set of house indicia selected for the game session is associated with each of the tickets 200 and/or player cards 202.

It should be recognized that player indicia 218, house indicia, and matched indicia 220 are all determined and printed on tickets 200 before the player is able to buy tickets 200. Accordingly, when the player removes scratch-off material 214 from each player card 202, matched indicia 220 for the game are revealed to the player in the form of pre-daubed or marked spaces 216 and/or player indicia 218. The player can then compare matched indicia 220 for each player card 202 to pay table 212 to determine if any matching patterns occur and what prize or prizes the player wins.

In the example illustrated in FIG. 2A, the player has completed three winning patterns on ticket 200: a letter T pattern on second player card 206, a single pattern on third player card 208, and a frame pattern on fourth player card 210. Based on the prizes listed on pay table 212, the player wins $100 for second player card 206, $1 for third player card 208, and $10,000 for fourth player card 210.

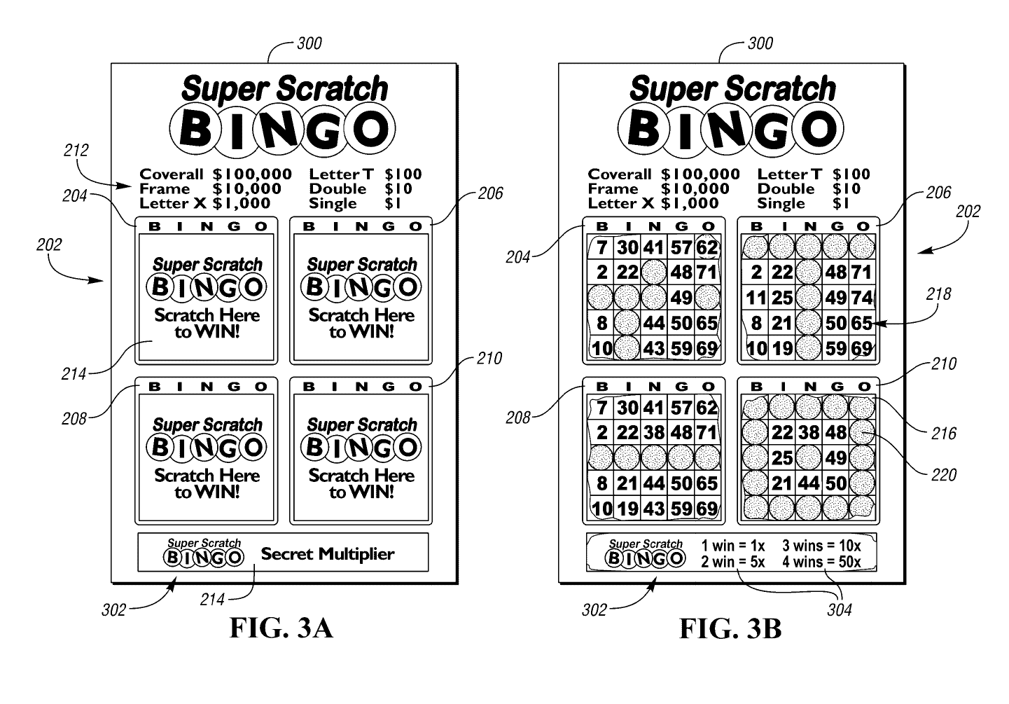

FIG. 3A is a plan view of an exemplary ticket 300 that may be used to play a game of chance, such as bingo. In one embodiment, ticket 300 is a scratch-off ticket that may be used to play a scratch-off game of bingo. FIG. 3B is a plan view of ticket 300 that has been scratched off or revealed.

As illustrated in FIGS. 3A and 3B, ticket 300 may include a multiplier portion 302 that may be covered by scratch-off material 214. When the scratch-off material 214 is removed, multiplier portion 302 may reveal one or more prize multipliers 304 for one or more player cards 202 of ticket 300. Prize multiplier 304 may include, for example, a number by which the prize identified in pay table 212 is multiplied by if the player satisfies a winning criterion and optionally if the player satisfies a criterion indicated by multiplier portion 302. For example, as illustrated in FIG. 3B, a player may win or receive a prize from pay table 212 that is multiplied by 1 if only 1 winning pattern is completed on ticket 300, by 5 if two winning patterns are completed on ticket 300, by 10 if 3 winning patterns are completed on ticket 300, and by 50 if 4 winning patterns are completed on ticket 300. In one embodiment, each prize is multiplied by the prize multiplier. Therefore, in the example shown in FIG. 3B, the player will win $1,000 for second player card 206 (i.e., $100*10), $10 for third player card 208 (i.e., $1*10), and $100,000 for fourth player card 210 (i.e., $10,000*10). Alternatively, only the highest prize or the lowest prize may be multiplied by prize multiplier 304. In an alternative embodiment, prize multiplier 304 may be a fixed multiplier that applies to all prizes in pay table 212 without regard to whether more than one winning pattern has been matched.

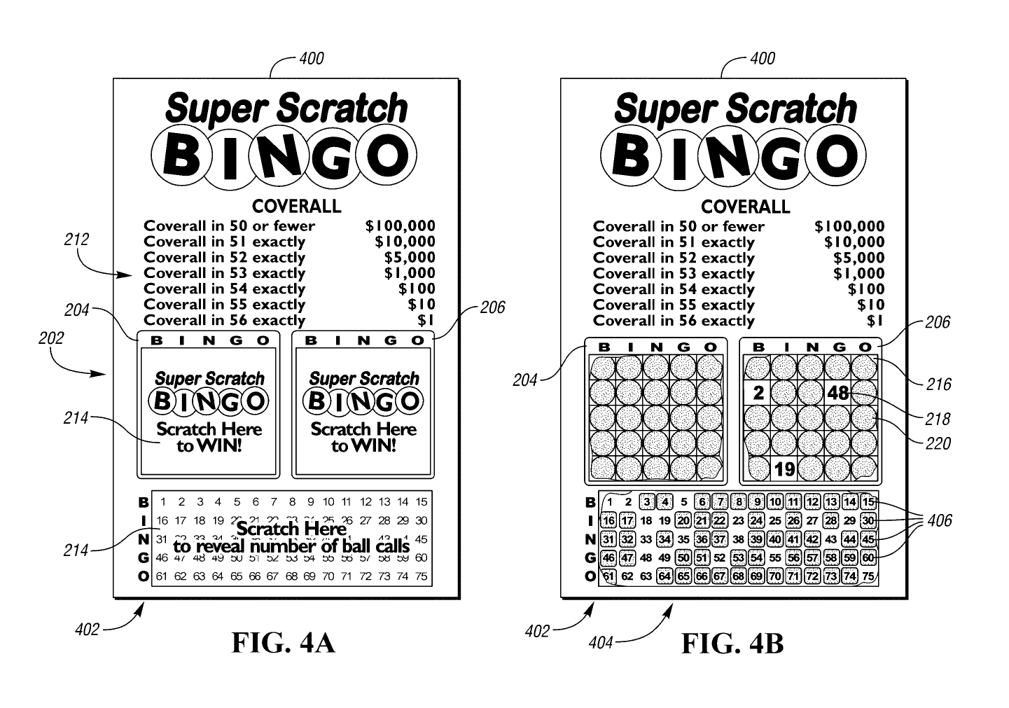

FIG. 4A is a plan view of an exemplary ticket 400 that may be used to play a game of chance, such as bingo. In one embodiment, ticket 400 is a scratch-off ticket that may be used to play a scratch-off game of bingo. FIG. 4B is a plan view of ticket 400 that has been scratched off or revealed.

As illustrated, in FIGS. 4A and 4B, ticket 400 may include a caller portion 402 that displays a flashboard 404 or other suitable display of house indicia 406 called or selected for the game, for ticket 400, and/or for player card 202. The called or selected house indicia 406 are daubed or otherwise marked on flashboard 404. In one embodiment, caller portion 402 is covered by scratch-off material 214 so that house indicia 406 (and the number of house indicia 406) selected for the game and for ticket 400 are obscured until scratch-off material 214 is removed. In addition, pay table 212 may include different prizes that the player may win based on the number of house indicia 406 selected for the game and for ticket 400.

In the example shown in FIG. 4B, 55 house indicia 406 were called and a coverall pattern has been matched on first player card 204. Accordingly, the player wins $10 based on pay table 212 (i.e., matching a coverall pattern in 55 house indicia calls).

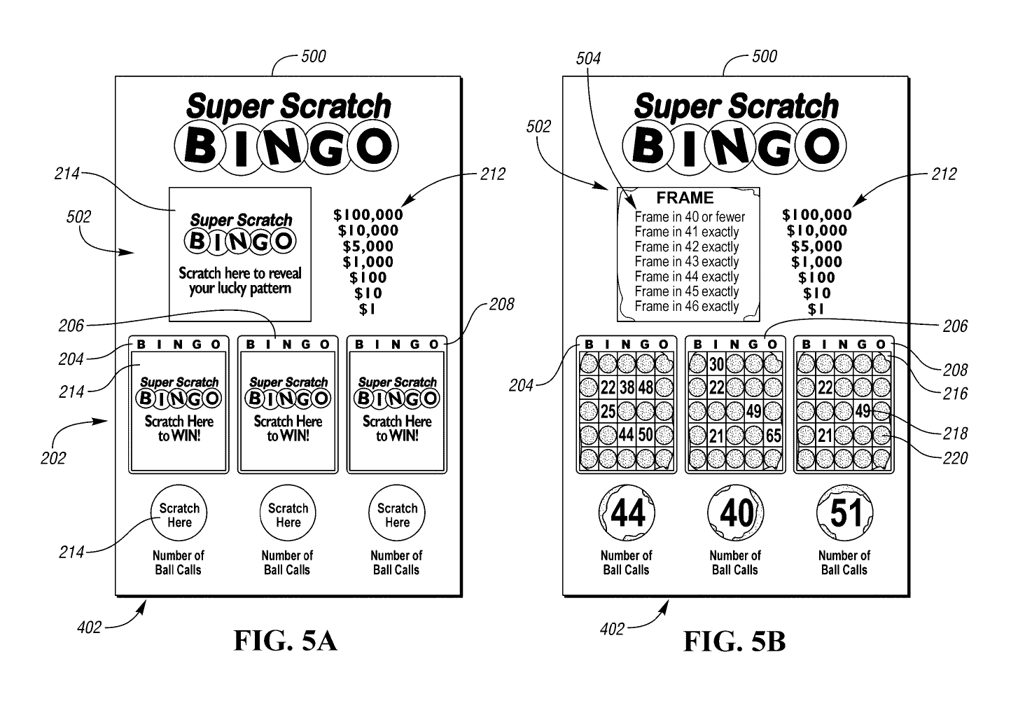

FIG. 5A is a plan view of an exemplary ticket 500 that may be used to play a game of chance, such as bingo. In one embodiment, ticket 500 is a scratch-off ticket that may be used to play a scratch-off game of bingo. FIG. 5B is a plan view of ticket 500 that has been scratched off or revealed.

As illustrated in FIGS. 5A and 5B, ticket 500 may include a caller portion 402 that displays the number of house indicia 406 selected for the game, ticket 500, and/or player card 202 without displaying the individual house indicia 406 selected. In addition, ticket 500 may include a pattern portion 502 that displays the winning pattern. 504 to be matched for player cards 202 on ticket 500. In one embodiment, both caller portion 402 and pattern portion 502 are covered or coated with scratch-off material 214. Pay table 212 may be included within pattern portion 502 or may be located next to pattern portion 502 as shown in FIGS. 5A and 5B.

In the example shown in FIGS. 5A and 5B, a different number of house indicia 406 may be selected for each player card 202. In the example shown, 44 house indicia 406 have been selected for first player card 204, 40 house indicia 406 have been selected for second player card 206, and 51 house indicia 406 have been selected for third player card 208. Alternatively, the same number of house indicia 406 may be selected for all or a group of player cards 202.

In the example shown in FIG. 5B, first player card 204 completed a winning frame pattern within 44 ball calls. As a result, the player wins $100 based on pay table 212. Second player card 206 did not complete a winning pattern so no prize is awarded for second player card 206. Third player card 208 completed a winning frame pattern in 51 ball calls. However, since pay table 212 only includes prizes for completing winning patterns up to and including 46 ball calls, the player does not receive a prize for third player card 208.

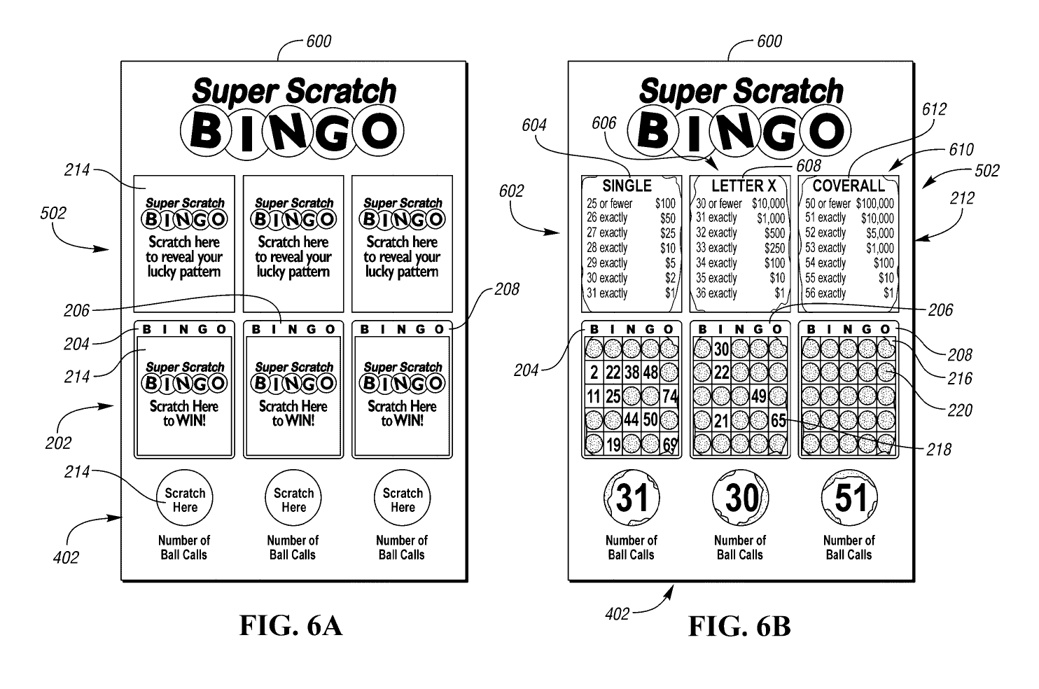

FIG. 6A is a plan view of an exemplary ticket 600 that may be used to play a game of chance, such as bingo. In one embodiment, ticket 600 is a scratch-off ticket that may be used to play a scratch-off game of bingo. FIG. 6B is a plan view of ticket 600 that has been scratched off or revealed.

As illustrated in FIGS. 6A and 6B, ticket 600 may include a plurality of pattern portions 502 that display the winning pattern 504 to be matched for each player card 202 on ticket 600. Pattern portions 502 may also include pay tables 212 for each winning pattern 504. In one embodiment, pattern portions 502 are covered or coated with scratch-off material 214.

In one embodiment, a different number of house indicia 406 may be selected for each player card 202 in a similar manner as described above with reference to FIGS. 54 and 5B.

In the example shown in FIG. 6B, a first pay table 602 includes a first set of prizes associated with matching a first winning pattern 604 (i.e., a single pattern in this example). A second pay table 606 includes a second set of prizes associated with matching a second winning pattern 608 (i.e., a letter X pattern), and a third pay table 610 includes a third set of prizes associates with matching a third winning pattern 612 (i.e., a coverall pattern). Continuing the example, first player card 204 completed a winning single pattern within 31 ball calls. As a result, the player wins $1 based on first pay table 602. Second player card 206 did not complete a winning letter X pattern according to second pay table 606 so no prize is awarded for second player card 206. Third player card 208 completed a winning coverall pattern in 51 ball calls. As a result, the player wins $10,000 based on third pay table 610.

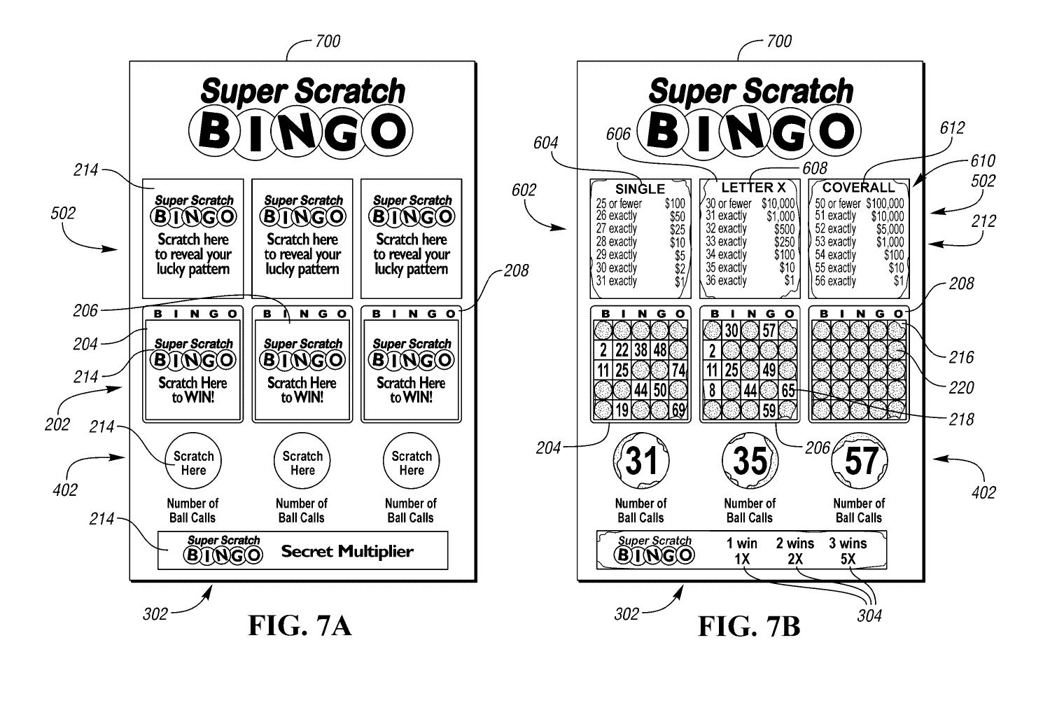

FIG. 7A is a plan view of an exemplary ticket 700 that may be used to play a game of chance, such as bingo. In one embodiment, ticket 700 is a scratch-off ticket that may be used to play a scratch-off game of bingo. FIG. 7B is a plan view of ticket 700 that has been scratched off or revealed.

As illustrated in FIGS. 7A and 7B, ticket 700 may include a plurality of player cards 202, a plurality of caller portions 402, one or more multiplier portions 302, and a plurality of pattern portions 502 that display winning patterns 504 and pay tables 212 for player cards 202. It should be recognized, however, that player card 202 may include any suitable number of player cards 202, caller portions 402, multiplier portions 302, pattern portions 502, winning patterns 504, and/or pay tables 212 as desired.

Caller portions 402 may include one or more displays of the number of ball calls or other house indicia calls that are associated with one or more player cards 202. In the example shown in FIG. 7B, each player card 202 is associated with a different number of ball calls. Each player card 202 is also associated with a separate pay table 212 with a separate winning pattern 504. A prize multiplier 304 may also be applied to any prize won based on multiplier portion 302.

In the example shown in FIG. 7B, a single winning pattern 504 must be matched or completed in 31 house indicia calls or less to win a prize for first player card 204 under first pay table 602. Since first player card 204 has matched a single winning pattern 504 within 31 house indicia calls, the player wins $1 for first player card 204. To win a prize for second player card 206 under second pay table 606, a letter X winning pattern 504 must be matched or completed in 36 house indicia calls. Since second player card 206 has matched a letter X winning pattern 504 within 35 ball calls, the player wins $10 for second player card 206. For third player card 208, a coverall winning pattern 504 must be matched within 56 house indicia calls to win a prize according to third pay table 610. In the example shown in FIG. 7B, the coverall winning pattern 504 was matched but only within 57 house indicia calls. Accordingly, no prize is won for third pay table 610.

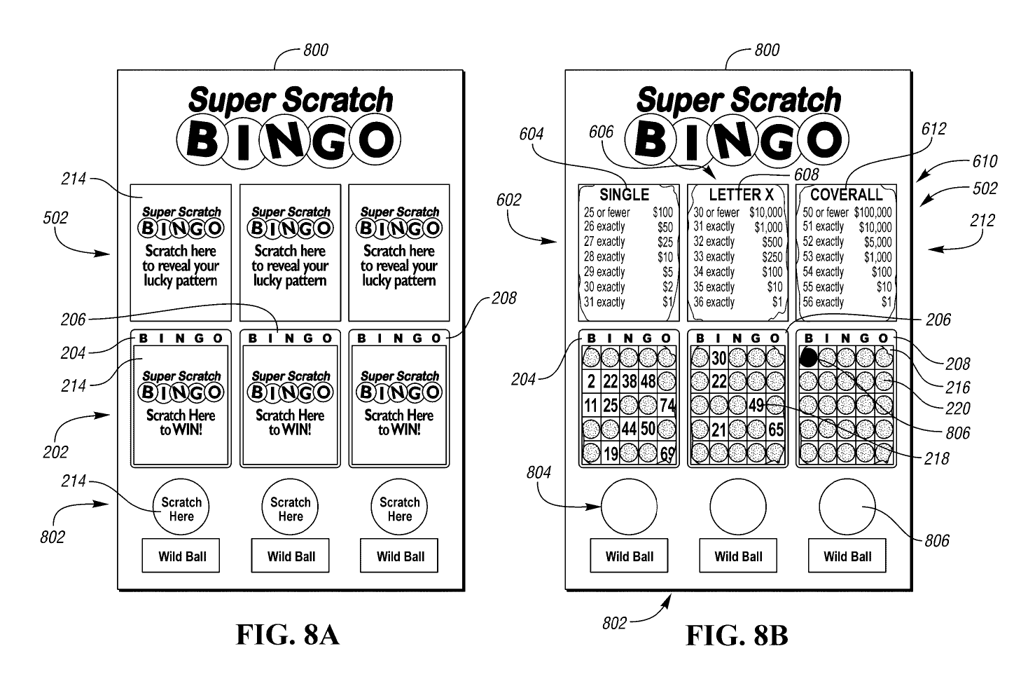

FIG. 8A is a plan view of an exemplary ticket 800 that may be used to play a game of chance, such as bingo in one embodiment, ticket 800 is a scratch-off ticket that may be used to play a scratch-off game of bingo. FIG. 8B is a plan view of ticket 800 that has been scratched off or revealed.

As illustrated in FIGS. 8A and 8B, ticket 800 may include a bonus portion 802 that displays a bonus status 804 indicating whether a bonus indicia 806 has been selected for one or more player cards 202. In one embodiment, each player card 202 has a chance of having one or more bonus indicia 806 selected. Bonus indicia 806 may include, for example, a wild ball, a bonus ball, and/or any other suitable indicia that provides a bonus for the associated player card 202 or cards 202. In one embodiment, bonus portion 802 is at least partially covered by scratch-off material 214 such that each bonus indicia 806 and/or bonus status 804 is obscured until the player removes scratch-off material 214.

Revealing a bonus ball may cause a prize to be increased or enhanced for a player card 202 if the bonus ball matches a player indicia 218 within a winning pattern 504 of player card 202. For example, a prize may be doubled, tripled, or otherwise increased if the bonus ball matches a player indicia 218 within winning pattern 504. Alternatively, if the bonus ball matches a player indicia 218 within a winning pattern 504, the player may be awarded one or more free games or free tickets 800.

The wild ball may be used to complete a winning pattern 504 by providing one or more missing player indicia 218 for the pattern. In one embodiment, if a player card 202 is missing one player indicia 218 to form a winning pattern 504, a wild ball selected for that player card 202 provides the missing player indicia 218 for determining whether player card 202 is entitled to a prize on an associated pay table 212. The player may manually daub a player indicia 218 within player card 202 if the wild ball is selected, or player card 202 may be pre-daubed with a marking representing the wild ball covering or overlaying the player indicia 218 that is needed to complete winning pattern 504. The pre-daubing or other marking of the wild ball may be completed when player card 202 and/or ticket 800 is created, or at any other suitable time before player card 202 and/or ticket 800 is provided to the player.

In the example shown in FIG. 8B, ticket 800 provides the chance of selecting or revealing a bonus indicia of a wild ball. In this example, a wild ball was not selected for first player card 204 or second player card 206. However, a wild ball was selected for third player card 208. In this example, third player card 208 was missing the first player indicia 218 in the “B” column to match the winning coverall pattern. Since the wild ball was selected, the missing player indicia 218 is provided by the wild ball and the player is considered to have completed the winning pattern for third player card 208. The missing player indicia 218 in this example is daubed with the wild ball symbol to create a matched indicia 220 that has a different symbol or marking as compared to the symbol or other marking of the remaining matched indicia 220 that are not associated with or provided by the wild ball. In one embodiment, the missing player indicia 218 is pre-daubed with the wild ball symbol when ticket 800 is printed or otherwise formed.

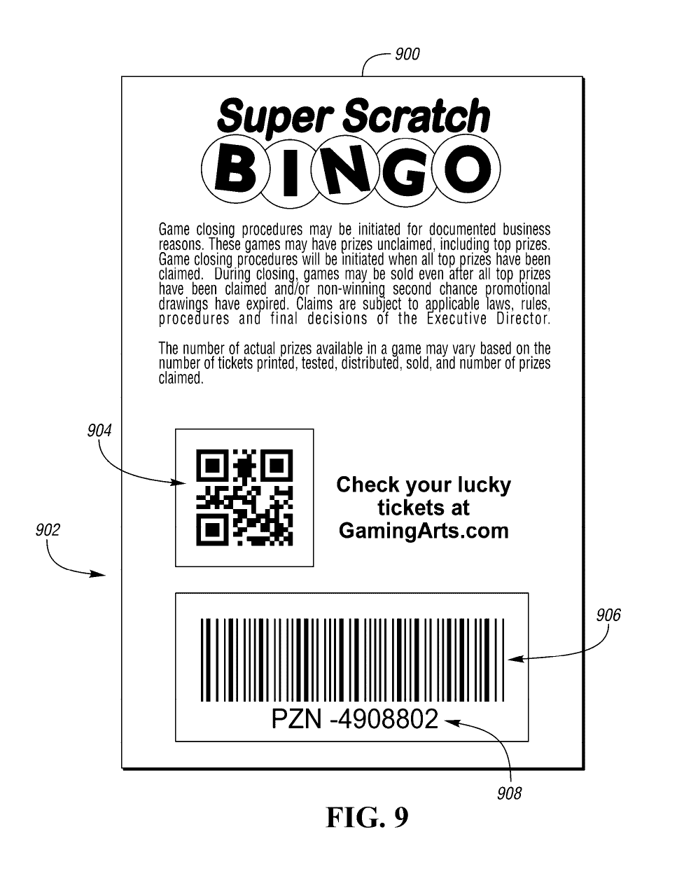

FIG. 9 is a plan view of an exemplary ticket 900 that may be used to play a game of chance, such as bingo. In one embodiment, ticket 900 may be printed or otherwise provided as a back side to another ticket described herein.

As illustrated in FIG. 9, ticket 900 may include one or more bar codes 902 or other ticket identifiers. For example, ticket 900 may include a 2 dimensional (2D) bar code 904 (also known as a “QR code”), a 1 dimensional (1D) bar code 906, and/or a serial number 908 to identify ticket 900 and the contents thereof.

Serial number 908 may be used to uniquely identify ticket 900 by an operator of the game of chance. For example, if tickets 900 are sold by a casino or another gaming establishment, serial numbers 908 of tickets 900 may be used to determine which tickets 900 have been sold and to identify winning tickets 900. In one embodiment, 1D bar code 906 may include a suitable machine-readable encoding of serial number 908.

2D bar code 904 may incorporate a Universal Resource Locator (URL) or another suitable link to a website for checking the winning status of ticket 900. 2D bar code 904 may also include a unique identifier (such as serial number 908) embedded within the URL or otherwise incorporated within 2D bar code 904. Accordingly, if a player scans 2D bar code 904 with an image capture device, such as a cellular phone camera, 2D bar code 904 may provide the URL and/or serial number 908 to the cellular phone of the player. The cellular phone may then load the website identified by the URL and may display information relating to ticket 900. In one embodiment, the website automatically displays whether any player cards 202 of ticket 900 have won a prize on an associated pay table 212, the value of the prize, and/or any other suitable information. The website may alternatively enable the player to manually enter the serial number 908 of ticket 900 into a field or other portion of the website to determine whether ticket 900 includes any winning player cards 202. In one embodiment, the player may automatically determine whether any player cards 202 have won a prize without the player needing to remove scratch-off material 214.

It should be recognized that a server or other computer may host the website and perform one or more of the functions described herein. For example, in one embodiment, the server may automatically receive the URL and/or serial number 908 or another ticket identifier from a device, such as a cellular phone, that in turn obtains the URL and/or identifier from 2D bar code 904. Alternatively, the server may receive the URL when the player enters the URL into a web browser and may receive serial number 908 when the player enters serial number 908 into a form or other portion of the website. The server may determine, based on the ticket identifier, whether the player is enabled to win a prize for one or more player cards of the ticket. The server may display a prize notification web page or may otherwise cause the website to display a notification of whether the player is enabled to win the prize.

A security mechanism may be built into the website to prevent the information relating to ticket 900 from being displayed until after ticket 900 is purchased by a player. Accordingly, in one embodiment, a point-of-sale (POS) terminal or other device that registers a sale of ticket 900 may transmit a notification to the server hosting the website. The notification may include a signal or message indicating that the ticket 900 associated with bar code 902 and/or serial number 908 has been sold. In response to the notification, the server may enable website to display the information relating to ticket 900, including a notification of whether any player cards 202 within ticket 900 are entitled to win a prize.

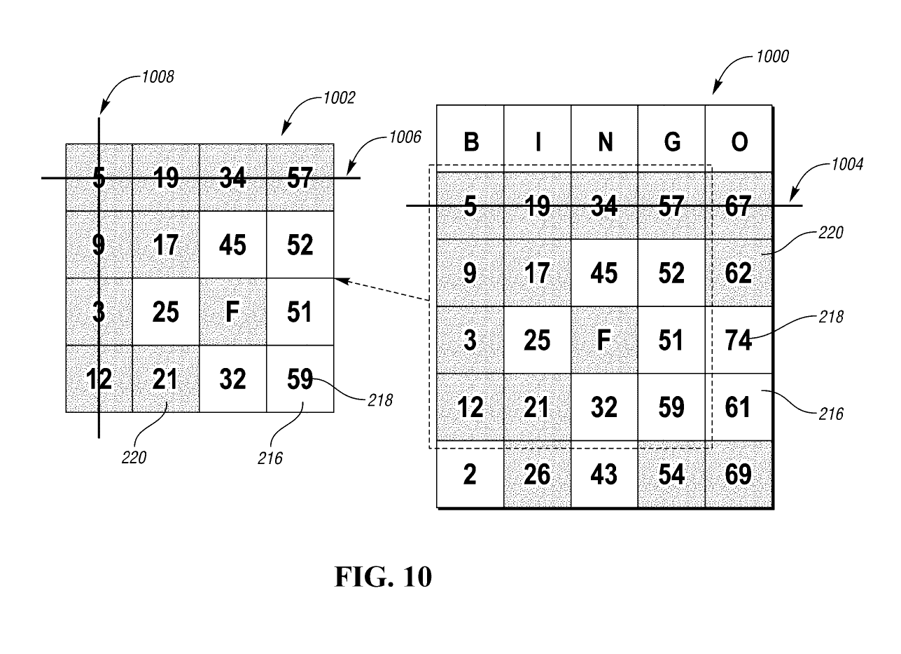

FIG. 10 is a plan view of an exemplary player card 1000 that may be used to play a game of chance, such as bingo. In one embodiment, player card 1000 (referred to herein as a “primary player card 1000”) may incorporate one or more secondary player cards 1002. In one embodiment, player card 1000 may be included within one or more tickets described herein with reference to FIGS. 1-9.

In the example shown in FIG. 10, primary player card 1000 is a 5×5 bingo player card. A 4×4 secondary player card 1002 may be incorporated within primary player card 1000 such that secondary player card 1002 is formed from a subset of spaces within primary player card 1000, such as a 4×4 matrix of spaces 216 within primary player card 1000. While only 1 secondary player card 1002 is shown in FIG. 10, it should be recognized that up to 4 secondary player cards 1002 may be incorporated within primary player card 1000 if secondary player card 1002 is a 4×4 card and primary player card 1000 is a 5×5 card. It should also be recognized that secondary player card 1002 or cards 1002 may be 3×3 cards and/or any suitable size and shape. If secondary player card 1002 is a 3×3 card, it should be recognized that up to 9 secondary player cards 1002 may be incorporated within a 5×5 primary player card 1000. However, any suitable number of secondary player cards 1002 may be incorporated within primary player card 1000, and any number of player cards of different sizes may be incorporated within the same primary player card 1000. For example, 1 or more secondary player cards 1002 having a 4×4 matrix of spaces 216 may be incorporated within primary player card 1000 and may include a subset of the spaces therein, and 1 or more tertiary player cards (not shown) having a 3×3 matrix of spaces 216 may be incorporated within secondary player card 1002 (and thereby within primary player card 1000 as well) and may include a subset of the spaces 216 of secondary player card 1002.

In one embodiment, a player may win separate prizes based on pattern matches within primary player card 1000 and pattern matches within secondary player card 1002. Accordingly, if a first winning pattern 1004 is matched on primary player card 1000, the player may win a first prize based on an associated pay table 212. If a second winning pattern 1006 is matched on secondary player card 1002, the player may win a second prize. In one embodiment, a winning pattern 504 of secondary player card 1002 may be a subset of a winning pattern 504 of primary player card 1000. In other words, winning pattern 504 of primary player card 1000 may incorporate all of the spaces 216 included within winning pattern 504 of secondary player card 1002.

In the example shown in FIG. 10, first winning pattern 1004 is matched within primary player card 1000. Second winning pattern 1006 is matched within secondary player card 1002, and second winning pattern 1006 is incorporated within, or a subset of, first winning pattern 1004. A third winning pattern 1008 is matched within secondary player card 1002 as well. Accordingly, in the example shown, the player wins prizes for each of the winning patterns (i.e., first winning pattern 1004, second winning pattern 1006, and third winning pattern 1008). In an alternative embodiment, the player may only win prizes for winning patterns 504 that are distinct: from each other such that the player does not win a prize for a winning pattern 504 on secondary player card 1002 that is fully incorporated within a winning pattern 504 on primary player card 1000.

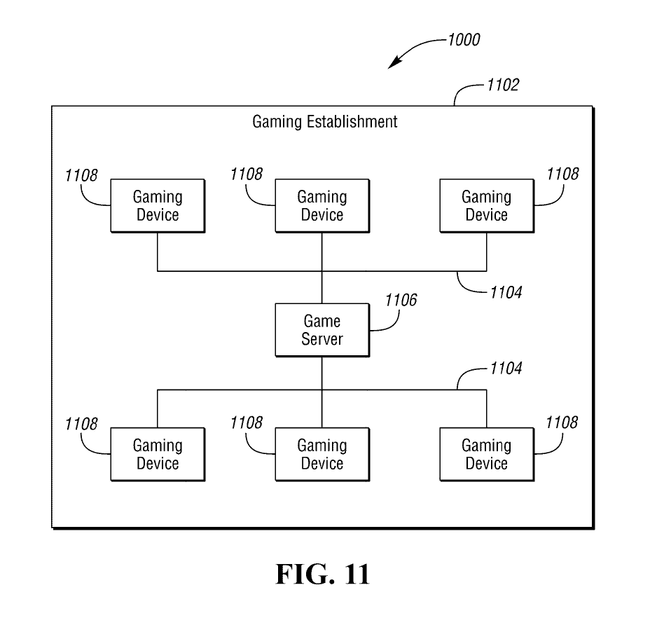

FIG. 11 is a block diagram of a system 1100 that may be used to play one or more games of chance, such as bingo or keno. In one embodiment, the scratch-off bingo game described in the above embodiments may be played electronically using system 1100. For example, system 1100 may implement one or more electronic or virtual scratch-off tickets and/or player cards that are similar to one or more of the tickets and/or player cards described in FIGS. 1-10.

System 1100 may be operated using components and devices within one or more gaming establishments 1102. It should be recognized that any suitable number of gaming establishments 1102 may be provided within system 1100. In one embodiment, gaming establishment 1102 is a location in which devices (e.g., gaming devices) that play or operate at least a portion of the game of chance are located. For example, gaming establishment 1102 may be a casino, racetrack, bingo hall, keno parlor, or any other establishment. In another example, gaming establishment 1102 may be a residence or business in which one or more devices are located for playing or operating the game of chance. Gaming establishment 1102 may additionally or alternatively include any combination of the examples described herein.

In one embodiment, devices and systems of gaming establishment 1102 are communicatively connected to at least one network 1104, such as a local area network (LAN), a casino area network (CAN), a wide area network (WAN), a metropolitan area network (MAN), and/or the Internet, for example. It should be recognized that network 1108 may be a wired Ethernet network, a wireless Ethernet network, a combination of wired and wireless Ethernet networks, or any other suitable wired and/or wireless network.

In one embodiment, gaming establishment 1102 includes one or more game servers 1106. Game server 1106 is coupled to a plurality of gaming devices 1108 through network 1104.

In one embodiment, game server 1106 is a server computer (or “server”) that monitors and controls the games played on gaming devices 1108, in addition, game server 1106 may administer other tasks that enable games to be played on gaming devices 1108. For example, game server 1106 may facilitate authenticating gaming devices 1108 and the players using gaming devices 1108, and may facilitate allocating payments or credits between players and gaming establishment 1102 (or the operator of the game). Game server 1106 may include payment processing capabilities to enable players to receive electronic funds from a bank or another financial institution or to deposit electronic funds to the bank or financial institution. Alternatively, the payment processing capabilities may be included in a separate server or another device that is communicatively connected to game server 1106. In addition, game server 1106 or another suitable server may facilitate tracking and administering player rewards.

Gaming devices 1108 may include one or more gaming kiosks or terminals, electronic gaming machines (EGMs) (also known as “slot machines”), lottery kiosks or terminals, desktop computers, or any other suitable device. Gaming devices 1108 may also include one or more mobile gaming devices 1108, such as, without limitation, cellular phones, tablet computing devices, laptops, or any other suitable device. Mobile gaming devices 1108 may connect to game server 1106 and network 1104 via a suitable wireless data network.

During operation, the player operates a gaming device 1108 and initiates a gaining session for playing one or more games of chance (“games”). Optionally, the player inserts a player reward card or enters a player reward number or other identification information into gaming device 1108. If the identification information is entered, gaming device 1108 transmits the identification information to game server 1106 or to another suitable device or system for authentication. Alternatively, player identification or authentication may be accomplished locally within gaming device 1108. Game server 1106 may establish the player's identity and may associate the gameplay with the player account. Game server 1106 authenticates the player and gaming device 1108 and authorizes the player to play the game or games on gaming device 1108 if desired or required.

When play of the game is initiated, during selection of the game, or during play of the game, the player may be required to purchase or generate credits. The player may purchase or generate credits by inserting cash or a voucher into gaming device 1108 or another device. Alternatively or additionally, the player may transfer credits or cash to gaming device 1108 from a banking account, credit account, gaming establishment account, and/or gaming company account. In one embodiment, computer-generated credits may be used with gaming device 1108, for example, as part of a free-to-play game.

The player selects a game to play and enters a wager on gaming device 1108. For example, the player may select an electronic scratch-off bingo game to play on gaming device 1108. Gaming device 1108 transmits data representative of the selected game and the wager to game server 1106.

The player then plays the game on gaming device 1108. The following gameplay is described as being administered by game server 1106. However, it should be recognized that the gameplay (i.e., the play of the game of chance) may be alternatively or additionally administered by gaming device 1108. For example, if gaming device 1108 is a cellular phone or a tablet computing device, the gameplay may be administered through an application installed on gaming device 1108.

In one embodiment, the player may play a game of scratch-off bingo by selecting one or more game tickets and/or player cards issued by game server 1106. In one embodiment, tickets and/or player cards are substantially similar to the tickets and/or player cards described above with reference to FIGS. 1-10 and may be displayed and operated in a similar manner (i.e., to look and operate substantially the same as shown in FIGS. 1-10). Each ticket may include one or more player cards with a plurality of spaces, and each player card is initially covered by a virtual scratch-off material or covering, such as a pattern, an image, a logo, a color, and/or another suitable covering or overlay that obscures the contents of the player card spaces.

The player may touch portions of the player card or otherwise operate gaming device 1108 to remove the virtual scratch-off material or overlay from the player card and to reveal the contents of the player card. For example, the player may touch each space on the player card to reveal the player indicia for that space. Alternatively, the player may select an icon to reveal the contents of all or a group of spaces of one or more player cards. If the player indicia is a matched indicia, the matched indicia may be displayed in the selected space in addition to, or in place of, the player indicia. The player may also reveal any multiplier portions, pay tables, pattern portions, caller portions, and/or any other suitable portions of the player cards by touching the respective location on the player card or by selecting a suitable icon or button. When the player card has been fully revealed (or when any winning patterns have been revealed.), any prize that the player has won for the player card may be revealed or displayed to the player on gaming device 1108. The player may then cash out any prize that the player won, or the player may continue to play additional player cards or tickets on gaming device 1108.

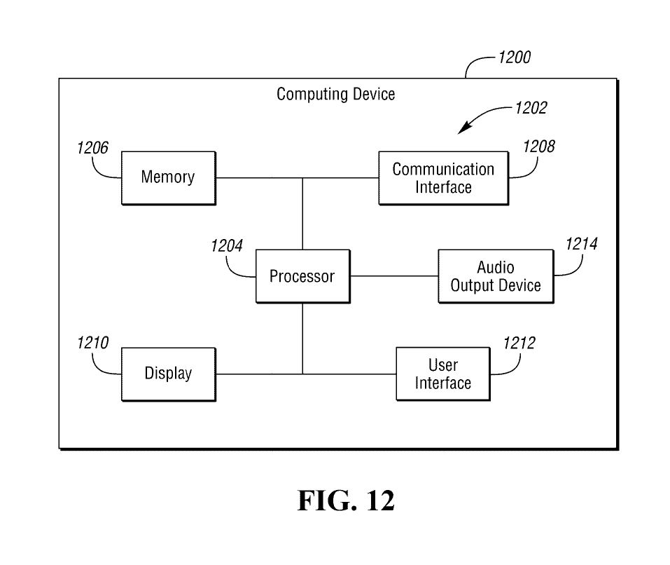

FIG. 12 is a block diagram of a computing device 1200 that may be used with system 1100 (shown in FIG. 11). More specifically, in one embodiment, one or more gaming devices 1108 and/or game servers 1106 described in system 1100 may be implemented as a computing device 1200.

Computing device 1200 includes a plurality of computing device components 1202, such as a processor 1204, a computer-readable memory device 1206, and a communication interface 1208. In one embodiment, computing device 1200 may also include a display 1210, a user interface 1212, and/or an audio output device 1214. It should be recognized that memory device 1206, communication interface 1208, display 1210, and user interface 1212 (if provided) may be connected to processor 1204 and/or to each other via any suitable bus or busses, interfaces, or other mechanisms.

Processor 1204 includes any suitable programmable circuit including one or more microcontrollers, microprocessors, application specific integrated circuits (ASICs), systems on a chip (SoCs), programmable logic circuits (PLCs), field programmable gate arrays (FPGAs), and/or any other circuit capable of executing the functions described herein. The above examples are exemplary only, and thus are not intended to limit in any way the definition and/or meaning of the term “processor.”

Memory device 1206 is an electronic storage device that includes transitory or non-transitory computer readable media, such as, without limitation, random access memory (RAM), flash memory, a hard disk drive, a solid state drive, a compact disc, a digital video disc, and/or any suitable memory. Memory device 1206 may include data as well as instructions that are executable by processor 1204 to program processor 1204 to perform the functions described herein. For example, the games described herein may be performed by one or more processors 1204 executing instructions stored within one or more memory devices 1206.

Communication interface 1208 may include, without limitation, a network interface controller (NIC) or adapter, a radio frequency (RF) transceiver, a public switched telephone network (PSTN) interface controller, or any other communication device that enables computing device 1200 to operate as described herein. In one embodiment, communication interface 1208 may connect to communication interfaces 1208 of other computing devices 1200 of system 1100 through network 1104 or another network using any suitable wireless or wired communication protocol.

Display 1210 may include, without limitation, a liquid crystal display (LCD), a vacuum fluorescent display (VFD), a cathode ray tube (CRT), a plasma display, a light-emitting diode (LED) display, a projection display, and/or any suitable visual output device capable of displaying graphical data and text to a user. For example, display 1210 may be used to display a graphical user interface to a player or an administrator, one or more images associated with a game of chance such as a scratch-off bingo, keno, or lottery game, player statistics, gameplay data, and/or any other suitable data.

User interface 1212 may include, without limitation, a keyboard, a keypad, a touch screen or touch-sensitive display, a mouse, a scroll wheel, a pointing device, an audio input device employing speech-recognition software, a video input device that registers movement of a user, and/or any other suitable device that enables the user to input data into computing device 1200 and/or retrieve data from computing device 1200.

Audio output device 1214 may include, without limitation, one or more speakers, or any other device that enables data to be audibly output from computing device 1200. For example, gameplay data and/or music may be audibly output from audio output device 1214. In addition, if the player wins a prize, audio output device 1214 may be used to alert the player and/or others about the win.

While the foregoing computing device components 1202 have been described as being included within a computing device 1200, it should be recognized that at least some computing devices 1200 may not include each component 1202. In addition, a computing device 1200 may include any suitable number of each individual computing device component 1202. For example, a computing device 1200 may include a plurality of processors 1204 or processor cores, a plurality of memory devices 1206 (of the same or different types, sizes, etc.), and/or a plurality of displays 1210.

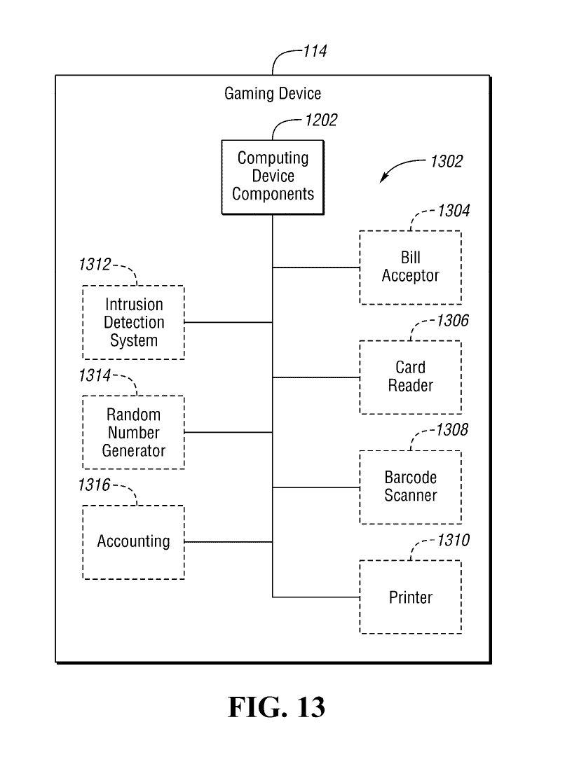

FIG. 13 is a block diagram of an exemplary gaming device 1108 that may be used with system 1100 (shown in FIG. 11). As described above, gaming device 1108 may be a computing device 1200 that includes a plurality of computing device components 1202. In addition, gaming device 1108 may include a plurality of gaming device components 1302 including a bill acceptor 1304, a card reader 1306, a barcode scanner 1308, a printer 1310, an intrusion detection system 1312, a randomization device 1314, and/or an accounting interface 1316.

It should be recognized that in some embodiments, a gaming device 1108 may not include each gaining device component 1302 illustrated in FIG. 13. For example, if gaming device 1108 is a cellular phone, gaining device 1108 may not include bill acceptor 1304, card reader 1306, barcode scanner 1308, and/or printer 1310. Rather, in some embodiments, the functions of each omitted gaming device component 1302 may be replaced by equivalent software, hardware, and/or firmware if desired. For example, the functionality of card reader 1306 and/or barcode scanner 1308 may be implemented by a cellular phone camera.

Bill acceptor 1304 is a payment input device that enables gaining device 1108 to receive and identify paper currency. For example, bill acceptor 1304 may receive and identify physical items associated with a monetary value, such as dollar bills or other currency, that are inserted into bill acceptor 1304. In one embodiment, bill acceptor 1304 includes a scanner that scans paper currency inserted therein. Bill acceptor 1304 may also include optical character recognition (OCR) capabilities that enable bill acceptor 1304 to identify the amount of currency inserted into bill acceptor 1304 from a scanned image of the currency. Bill acceptor 1304 may transmit data representative of the amount of currency inserted into gaming device 1108 to processor 1204, for example. Processor 1204 may cause the amount of currency to be converted into credits usable with the game, and may add the credits to the player's credit balance or account.

Card reader 1306 is a device that “reads,” or obtains data encoded in, player reward cards or other cards or media that are inserted into reader 1306. In one embodiment, card reader 1306 is a magnetic card reader that reads barcodes or magnetic strips included within a player reward card. In another embodiment, card reader 1306 wirelessly reads data encoded within the player reward card by accessing a chip, such as a radio frequency identification (RFID) chip, embedded within the card. Card reader 1306 decodes the data obtained from the cards and transmits the decoded data to processor 1204. In one embodiment, card reader 1306 is used to read player identification information encoded within player reward cards. Processor 1204 may transmit the player identification information to game server 1106 to identify the player, to allow for the transfer of funds or credits, to facilitate authenticating the player, and/or to authorize the player to play a game on gaming device 1108. In one embodiment, the player may “log in” to gaming device 1108 by swiping the player reward card or otherwise passing the player reward card through, or inserting the player reward card within, card reader 1306. In another embodiment, the player may enter a number or other identifier associated with the player reward card into gaming device 1108, through user interface 1212 for example, instead of using card reader 1306. In another embodiment, the insertion of the player reward card and player entering the identifier into user interface 1212 may be combined. In yet another embodiment, the player may use a near field communication (NFC) device, such as an NFC device incorporated within communication interface 1208, to read the player reward card or data representative of the player card.

In one embodiment, barcode scanner 1308 is an optical or a magnetic scanner that is optimized to read barcodes on media positioned proximate to scanner 1308. For example, barcode scanner 1308 may be optimized to read barcodes printed on paper receipts (sometimes referred to as “tickets” or vouchers, not to be confused with game or player tickets that may include player indicia and the like) and/or barcodes displayed electronically on a cell phone or tablet computing device. It should be recognized that the barcodes read by barcode scanner 1308 may be linear or one-dimensional barcodes, two-dimensional barcodes, or may even include data represented in a form other than a barcode. For example, barcode scanner 1308 may read images and/or text indicative of data, such as currency or credits, usable with gaming device 1108. Barcode scanner 1308 extracts the data from the barcode and transmits the data to processor 1204. For example, barcode scanner 1308 may scan a paper receipt or voucher that includes an amount of currency or credits usable by the player with a gaming device 1108 and may transmit the amount of credits to processor 1204. In such an example, barcode scanner 1308 may act as a payment input device to receive or read one or more physical items associated with a monetary value. Processor 1204 may cause the amount of currency or credits to be added to a currency or credit balance for the player on gaming device 1108 or on another suitable device or system. Processor 1204 may also cause the amount of currency or credits to be displayed to the player on display 1210 to inform the player how many credits or currency is available to be used in playing a game.

Printer 1310 may be used to print paper receipts also known as tickets as described above) that indicate an amount of currency or credits available to the player. In many locations, the tickets or receipts may alternatively be referred to as vouchers. Printer 1310 may act as a payment output device that enables a player to cash out or withdraw money or credits from gaming device 1108 by printing a voucher representative of the money or credits when the player initiates a cash out operation using, for example, user interface 1212 of gaming device 1108. In one embodiment, printer 1310 is a thermal printer that is fed by a roll of paper or any suitable paper stock. In a further embodiment, the roll of paper includes one or more watermarks that are visible when printer 1310 has printed the receipt on the paper. Alternatively, printer 1310 may print the watermark on the receipt, or may include another security mechanism to facilitate preventing counterfeit receipts from being made. For example, printer 1310 may include an image or a code on the receipt that identifies gaming device 1108, printer 1310, or another component of gaining device 1108 along with a time that the receipt was printed. Other suitable security mechanisms may be used as well. It should be recognized that barcode scanner 1308 and printer 1310 may cooperate such that a security mechanism printed on the receipt may be received and validated by barcode scanner 1308, in conjunction with processor 1204, for example. Barcode scanner 1308 may be located remotely from gaming device 1108, such as within a redemption kiosk, a casino cage, or the like.

Intrusion detection system 1312 may notify processor 1204 if a case, cabinet, or other housing enclosing components of gaming device 1108 is opened or modified without authorization. In one embodiment, intrusion detection system 1312 includes a pair of contacts that transmit an electronic signal to processor 1204 if the housing of gaming device 1108 is opened (e.g., if the opening of the housing separates the contacts). In another embodiment, intrusion detection system 1312 may include a light sensor that detects a change in the light within the housing of gaming device 1108. Intrusion detection system 1312 may also include a key or another mechanism for disabling the transmission of the signal to processor 1204 in the event that maintenance or other authorized access to components of gaming device 1108 is desired.

In one embodiment, intrusion detection system 1312 includes a software program (a “monitoring program”) that monitors one or more applications installed on gaming device 1108. For example, if gaming device 1108 is a cell phone that includes an application for playing the game thereon, the monitoring program may monitor the application to determine whether the application is modified without authorization. In one embodiment, the monitoring program stores a hash value or a digital fingerprint of the application when the application is installed and/or when the application undergoes authorized modification (e.g., if the application is updated or patched). However, if the monitoring program determines that the application has been modified without authorization, the monitoring program may cause a signal or another notification to be transmitted to processor 1204. For example, the monitoring program may periodically calculate a new hash value of the application and/or create a new digital fingerprint of the application. The monitoring program then compares the new hash value and/or digital fingerprint to the stored hash value and/or digital fingerprint. If the hash values or fingerprints are different, the monitoring program may determine that the application has been modified without authorization. It should be understood that the hash value, the monitoring program, and/or the digital fingerprint may be generated by any suitable means and may be encrypted for additional security.

In response to the signal or notification from intrusion detection system 1312 and/or the modification program, processor 1204 may perform one or more actions. For example, processor 1204 may alert an administrator within gaming establishment 1102 by transmitting a message via communication interface 1208, may cause audio output device 1214 to emit an alarm or another audible alert, may cause display 1210 to display an error or a warning, and/or may disable the application and/or gaming device 1108 such that the game is unable to be played on gaming device 1108.

In one embodiment, randomization device 1314 is an electronic random number generator (RNG) 1314 or a permutation generator that may be implemented by a dedicated hardware device with associated embedded software. Alternatively, RNG 1314 or the permutation generator may be implemented entirely in software executing on gaining device 1108. RNG 1314 may be used to randomly determine a game outcome for the game of chance. In one embodiment, RNG 1314 or the permutation generator provides house or game draws of between 1 and n numbers, where n may be a suitable number based on the game type selected to be played by the player. RNG 1314 or the permutation generator may be programmed via hardware, software, or firmware to provide a particular range of numbers other indicia and numbers of draws for a particular application. For example, in one embodiment of bingo according to the present disclosure, RNG 1314 or the permutation generator provides 45 randomly generated numbers having values between 1 and 75 for each game. In addition, RNG 1314 or the permutation generator may be used to randomly select a plurality of player indicia to be used with one or more player cards. In embodiments in which a processor, such as processor 1204, is described as randomly selecting indicia, it should be recognized that processor 1204 may interface with randomization device 1314 or the permutation generator to select the indicia. In other embodiments, processor 1204 may include randomization device 1314 or the permutation generator, or may execute instructions to perform the functions of randomization device 1314 or the permutation generator.

Accounting interface 1316 is used to interface with an accounting system, such as a slot accounting system, at or operated by a gaming establishment 1102. Accounting interface 1316 may include or be connected to a network interface, such as communication interface 1208 for use in communicating gameplay data, player identification information, and/or other data to the accounting system for accounting and/or auditing purposes.

Exemplary embodiments of scratch-off tickets and associated devices and systems are described above in detail. The tickets, devices, and systems are not limited to the specific embodiments described herein, but rather, components of the tickets, devices, and/or systems may be utilized independently and separately from other components described herein. For example, the scratch-off tickets, devices, and systems may also be used in combination with other games, and are not limited to practice with only the scratch-off bingo games of chance as described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to describe embodiments of the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A player ticket for use in a game of chance, said player ticket comprising:
a first layer comprising:
at least one player card comprising a plurality of spaces, wherein at least one of a player indicia and a matched indicia is displayed within each said space, and wherein each said matched indicia represents one of said player indicia that matches a house indicia selected for the game of chance; and
at least one multiplier portion that displays a prize multiplier for said at least one player card; and
a second layer comprising a removable material disposed upon at least a portion of said at least one player card and said at least one multiplier portion, wherein removing said removable material causes said player indicia, said matched indicia, and said prize multiplier to be revealed to a player.

2. The player ticket of claim 1, wherein the player is enabled to win a prize if said matched indicia on said at least one player card satisfies a winning criterion.

3. The player ticket of claim 2, wherein the prize is multiplied by the prize multiplier for said at least one player card,

4. The player ticket of claim 2, wherein the winning criterion includes matching a winning pattern by said matched indicia.

5. The player ticket of claim 2, wherein the winning criterion includes revealing a winning number of said matched indicia.

6. The player ticket of claim 2, wherein said at least one player card includes at least two player cards, and said at least one multiplier portion includes a different prize multiplier for each said player card.

7. The player ticket of claim 2, wherein said at least one player card includes at least two player cards and said at least one multiplier portion includes a plurality of prize multipliers.

8. The player ticket of claim 7, wherein a prize multiplier of said plurality of prize multipliers is selected based on a number of pattern matches completed on said at least two player cards, and wherein the prize won by the player is multiplied by said selected prize multiplier.

9. The player ticket of claim 7, wherein a selected prize multiplier of said plurality of prize multipliers is selected based on a number of said at least two player cards that have satisfied the same winning criterion, and wherein the prize on by the player is multiplied by said selected prize multiplier.

10. A player ticket for use in a game of chance, said player ticket comprising:
a first layer comprising:
at least one player card comprising a plurality of spaces, wherein at least one of a player indicia and a matched indicia is displayed within each said space, and wherein each said matched indicia represents one of said player indicia that matches one of a plurality of house indicia that have been selected for said at least one player card; and
a caller portion that displays a number of said plurality of house indicia that have been selected for the game of chance; and
a second layer comprising a removable material disposed upon at least a portion of said at least one player card and said caller portion, wherein removing said removable material causes said player indicia, said matched indicia, and said caller portion to be revealed to a player.

11. The player ticket of claim 10, wherein the player is enabled to win a prize if said matched indicia on said at least one player card satisfies a winning criterion.

12. The player ticket of claim 11, wherein the winning criterion includes matching a winning pattern by said matched indicia.

13. The player ticket of claim 12, wherein the prize is based on the number of said house indicia displayed within said caller portion.

14. The player ticket of claim 10, wherein said at least one player card includes at least two player cards, and wherein a different number of said plurality of house indicia is selected for each said player card.

15. The player ticket of claim 14, wherein said caller portion displays the number of said house indicia that have been selected for each said player card.

16. The player ticket of claim 15, wherein the player is enabled to win at least one prize based on the displayed number of said house indicia for each said player card that satisfies a winning criterion.

17. The player ticket of claim 10, wherein said caller portion displays each said house indicia that were selected for said at least one player card.

18. A player ticket for use in a game of chance, said player ticket comprising:
at least one player card comprising a plurality of spaces, wherein at least one of a player indicia and a matched indicia is displayed within each said space, and wherein each said matched indicia represents one of said player indicia that matches one of a plurality of house indicia that have been selected for said at least one player card;
at least one pattern portion that displays a winning pattern to be matched for said at least one player card;
at least one pay table that displays a prize to be won upon a determination that said matched indicia within said at least one player card matches said winning pattern; and
a removable material disposed upon at least a portion of said at least one player card and said at least one pattern portion, wherein removing said removable material causes said player indicia, said matched indicia, and said winning pattern to be revealed to a player.

19. The player ticket of claim 18, wherein said at least one player card includes a plurality of player cards and wherein said at least one pay table includes a separate pay table for each said player card.

20. The player ticket of claim 19, wherein at least a portion of each said pay table is covered by said removable material.

21. The player ticket of claim 19, wherein said at least one pattern portion displays a separate winning pattern for each said player card.

22. A player ticket for use in a game of chance, said player ticket comprising:
at least one player card comprising a plurality of spaces, wherein at least one of a player indicia and a matched indicia is displayed within each said space, and wherein each said matched indicia represents one of said player indicia that matches one of a plurality of house indicia that have been selected for said at least one player card;
at least one bonus portion that displays whether a bonus indicia has been selected for said at least one player card;
at least one pay table that displays a prize to be won upon a determination that said matched indicia within said at least one player card satisfies a winning criterion; and
a removable material disposed upon at least a portion of said at least one player card and at least a portion of said at least one bonus portion, wherein removing said removable material causes said player indicia, said matched indicia, and any said bonus indicia to be revealed to a player.

23. The player ticket of claim 22, wherein the winning criterion is satisfied if said matched indicia on said at least one player card matches said winning pattern.

24. The player ticket of claim 23, wherein the prize is increased if said bonus indicia is selected.

25. The player ticket of claim 22, wherein said bonus indicia enables the prize to be won even if said winning pattern has not been formed by said matched indicia.

26. The player ticket of claim 25, wherein said bonus indicia provides at least one additional matched indicia to form said winning pattern.

27. The player ticket of claim 26, wherein said at least one additional matched indicia provided by said bonus indicia is marked on said at least one player card before said ticket is provided to the player.

28. The player ticket of claim 27, wherein said matched indicia not provided by said bonus indicia are marked on said at least one player card with a different marking than the mark associated with said at least one additional matched indicia provided by said bonus indicia.

29. The player ticket of claim 22, wherein said at least one player card comprises a plurality of player cards and wherein said bonus portion includes a separate display of whether a bonus indicia is provided for each said player card.

30. A player ticket for use in a game of chance, said player ticket comprising:
a first player card comprising a first plurality of spaces, wherein at least one of a player indicia and a matched indicia is displayed within each of said first plurality of spaces, and wherein each said matched indicia represents one of said player indicia that matches one of a plurality of house indicia that have been selected for said first player card;
a second player card incorporated within said first player card, wherein said second player card comprises a second plurality of spaces that is a subset of said first plurality of spaces;
a first pay table that displays a first prize to be won upon a determination that said matched indicia within said first player card match a first winning pattern;
a second pay table that displays a second prize to be won upon a determination that said matched indicia within said second player card match a second winning pattern; and
a removable material disposed upon at least a portion of said first player card and said second player card; wherein removing said removable material causes said player indicia and said matched indicia within said first player card and said second player card to be revealed to a player.

31. The player ticket of claim 30, wherein said second winning pattern is a subset of said first winning pattern.

32. The player ticket of claim 30, wherein matching said first winning pattern enables the player to win the first prize and the second prize.

33. The player ticket of claim 32, wherein matching said second winning pattern but not said first winning pattern enables the player to win the second prize but not the first prize.

34. The player ticket of claim 30, further comprising a third player card that is incorporated within said first player card and said second player card.

35. The player ticket of claim 34, wherein said third player card comprises a third plurality of spaces that are a subset of said first plurality of spaces and said second plurality of spaces.

36. The player ticket of claim 30, wherein said second plurality of spaces includes said player indicia and said matched indicia that are included within associated spaces of said first plurality of spaces.

37. A system for use in a game of chance, said system comprising:
a player ticket comprising:
at least one player card comprising a plurality of spaces, wherein at least one of a player indicia and a matched indicia is displayed within each said space, and wherein each said matched indicia represents one of said player indicia that matches one of a plurality of house indicia that have been selected for said at least one player card;
at least one pay table that displays a prize to be won upon a determination that said matched indicia within said at least one player card matches a winning pattern;
a removable material disposed upon at least a portion of said at least one player card, wherein removing said removable material causes said player indicia and said matched indicia to be revealed to a player; and
a ticket identifier that enables a player to determine whether the player is enabled to win the prize for said at least one player card without removing said removable material; and
a device configured to:
receive said ticket identifier;
determine whether the player is enabled to win the prize for said at least one player card based on said ticket identifier; and
display a notification of whether the player is enabled to win the prize.

38. The system of claim 37, wherein said ticket identifier comprises a two-dimensional (2D) bar code comprising a universal resource locator (URL) that identifies a website.

39. The system of claim 38, wherein said 2D bar code further comprises a serial number that identifies said player ticket.

40. The system of claim 39, wherein said device is a server that hosts the website, said server is configured to receive the URL and the serial number and to display a web page with the notification of whether the player is enabled to win the prize.

41. The system of claim 37, wherein said ticket identifier comprises a bar code that the player is enabled to enter into said device to determine whether the player is enabled to win the prize for said at least one player card.

42. The system of claim 37, wherein said device is configured to receive a notification when said player ticket is sold to the player.

43. The system of claim 42, wherein said device is configured to prevent the notification of whether the player is enabled to win the prize until after said device receives the notification of the player ticket being sold to the player.

44. A gaming device comprising:
an input device configured to receive a physical item associated with a monetary value;
a user interface configured to:
enable a player to select a wager for a game of chance;
enable the player to initiate a cash out operation; and
accept an input from the player;
a display;
a player ticket configured to be displayed on said display, said player ticket comprising:
at least one player card comprising a plurality of spaces, wherein at least one of a player indicia and a matched indicia is displayed within each said space, and wherein each said matched indicia represents one of said player indicia that matches one of a plurality of house indicia selected for said at least one player card;
at least one pay table that displays a prize to be won upon a determination that said matched indicia within said at least one player card matches a winning pattern; and
a covering that obscures at least a portion of said at least one player card, wherein removing said covering causes said player indicia and said matched indicia to be revealed to the player; and
a processor programmed to:
add the monetary value to a credit balance for the player;
deduct the selected wager from the credit balance;
present the game of chance to the player;
remove said covering from said at least one player card in response to the input; and
decrease the credit balance in response to the cash out operation.

45. The gaming device of claim 44, wherein said processor is programmed to remove said covering from each said space in response to the input from the player.

46. The gaming device of claim 44, wherein the input from the player represents a selection of a space of said plurality of spaces, wherein said processor is programmed to remove said covering from said selected space.

47. The gaming device of claim 44, further comprising a randomization device configured to randomly select said plurality of house indicia.
